(19) United States
(12) Patent Application Publication
(10) Pub. No.: US 2016/0101715 A1
(43) Pub. Date: Apr. 14, 2016

(54) MANUAL LEVER CONTROLLER FOR RECLINER

(71) Applicant: Martin KRISTEN, Gelsenkirchen (DE)

(72) Inventor: Martin KRISTEN, Gelsenkirchen (DE)

(21) Appl. No.: 14/554,957

(22) Filed: Nov. 26, 2014

(30) Foreign Application Priority Data
Oct. 8, 2014 (DE) 202014104817.0

(51) Int. Cl. B60N 2/44; B60N 2/22

(52) U.S. Cl. CPC B60N 2/442; B60N 2/22

(57) ABSTRACT

A manual controller for operating two drives of a recliner has a housing and a lever projecting from the housing and movable in a forward direction from a rest position through a first forward position and then into a second forward position and rearward from the rest position through a first rearward position and then into a second rearward position. The first positions lie between the respective second positions and the rest position. Two first switches in the housing are each operated by the lever only in a respective one of the first positions, and two second switches in the housing are each operated by the lever only in a respective one of the second positions. Two of the switches are connected to one of the drives and the other two of the switches are connected to the other of the drives.

### FIELD OF THE INVENTION

The present invention relates to a switch. More particularly this invention concerns a manual or lever-type switch controller for operating a piece of reclining furniture.

### BACKGROUND OF THE INVENTION

The invention relates to a manual lever controller for an electrical actuator of a piece of seating or reclining furniture, in particular, a reclining arm chair, for example, from a base sitting position with the footrest retracted and the back upright to a comfort reclined position with the footrest raised and the back reclined and back to the base sitting position. Such a manual controller typically has a housing in which various switches including actuating buttons are provided to actuate the electrical drives of the recliner. These switches can be actuated by a hand lever projecting from the housing by moving the hand lever forward or rearward to shift the recliner from the base position to the comfort position and back to the base position. The manual controller is connected or can be connected by a power cable to the electrical drives and/or an electrical power source.

Manual controllers of this type are well known in the art and when used, for example, in reclining arm chairs are often bolted to the side of the seat of the reclining arm chair. A user can always only actuate only one motor by this type of manual controller. For example, pressing the hand lever forward actuates the motor for moving the reclining arm chair to the comfort position to be actuated, while pulling the same hand switch back effects a rearward motion, for example, from the comfort position to the base position of the reclining arm chair. In other words, this type of manual controller always allows only one motor to be actuated in two directions.

Given the increase in comfort required by many consumers, using this hand switch with multiple motors, in particular, two-motor systems, is impossible, or is possible only by incorporating a second manual controller.

### OBJECTS OF THE INVENTION

It is therefore an object of the present invention to provide an improved manual switch controller for recliner.

Another object is the provision of such an improved manual switch controller for recliner that overcomes the above-given disadvantages, in particular that allows multiple motors of recliner, in particular, of a reclining arm chair, to be quickly and easily operated by only one lever.

### SUMMARY OF THE INVENTION

A manual controller for operating two drives of a recliner movable between a base position and a comfort position has according to the invention a housing and a lever projecting from the housing and movable in a forward direction from a rest position through a first front position and then into a second front position and rearward from the rest position through a first rearward position and then into a second rearward position. The first positions lie between the respective second positions and the rest position. Two first switches in the housing are each operated by the lever only in a respective one of the first positions, and two second switches in the housing are each operated by the lever only in a respective one of the second positions. Two of the switches are connected to one of the drives and the other two of the switches are connected to the other of the drives.

This provision of multiple successive switches enables at least two successive switches to be actuated by operating only one hand lever in one direction. These switches can each control either a respective motor or one motor in different directions. For example, the footrest motor of a reclining arm chair can be moved to raise the footrest by pressing the hand lever in the forward direction into the first front position, and the foot motor can be moved in the opposite direction to lower the footrest by continuing to press the hand lever further in the toward direction into the second front position.

In addition, another motor, such as, for example, a seat-back motor of the reclining arm chair can also be set in motion to recline the seat back by pulling the hand lever in the rearward direction into the first rearward position, and the seat-back motor can be moved in the opposite direction to raise the seat back by continued pulling in the rearward direction onto the second rearward position.

This approach thus enables at least four electric-motor-actuated motions to be controlled on a recliner by only one hand lever.

In particular, the housing is of a flat rectangular shape, and the hand lever projects approximately centrally from one of the flat longitudinal sides and is connected to a switch element that is rotatable in the housing. The switch element first actuates one actuating button of a first forward or rearward switch in the housing in response to a forward motion or a rearward motion, and in response to subsequent motion in the same direction operates an actuating button of a second forward or rearward switch. The switch element is provided approximately centrally between two switch pairs in the housing, and the switch element includes switching cam bumps projecting radially toward the switches. In the rest position the cams are close to the actuating buttons of the first switches, and in the first operating position actuate an actuating button of one of the first switches and in a subsequent operating position in the same direction actuate an actuating button of the respective second switch.

This arrangement enables multiple switches comprising multiple actuating buttons to be provided inside the housing and attached, for example, to the reclining arm chair in the known way without significantly increasing the size of the housing. This arrangement of switches with actuating buttons and a switch element actuating the buttons provides a housing that is of the flat design known per se. A familiar operation can be retained and expanded to include additional functions. By this arrangement, for example, various motors can be operated successively by pivoting the hand lever in one direction, or one motor can be operated in different directions.

In addition, provision can especially preferably be made where in a first operating position a switching cam of the switch element actuates an actuating button of the switch pair on one side of the switch element, and in the subsequent operating position in the same direction another switching cam of the switch element actuates an actuating button of the switch pair on the other side of the switch element.

In this embodiment of the invention, for example, adjusting the hand lever in the forward direction means that the hand lever first actuates an actuating button of a switch on the side opposite the operating direction inside the housing, while subsequent adjustment of the hand lever in the same direction means that another switching cam of the switch element actuates an actuating button of a switch that is provided on the side of the housing facing the operating direction, that is, diagonally relative to the first actuated actuating button inside the housing.

In addition, provision can especially preferably be made whereby a first switching cam actuates a first actuating button when the switch element is rotated 5° in each direction relative to the rest position, and another switching cam actuates another actuating button when the switch element is rotated 11° relative to the rest position.

When the hand lever is operated, actuation of one of the first switches is effected after the switch element connected to the hand lever is rotated 5° relative to the rest position in the forward direction or in the rearward direction. When the switch element is rotated further by operating the hand lever, another actuating button is effected when the switch element is rotated 11° relative to the rest position. This easily enables the user to control various supporting actions by the motor.

According to the invention the hand lever is held against the force of a spring in the rest position in order to preclude improper operation and to allow especially easy operation of the manual controller. In accordance with the invention a projecting arm is provided on the switch element on the side opposite the hand lever and is provided in the housing between two precompressed springs.

This arrangement ensures that the hand lever always returns to the rest position when not operated by a user, or is held in this position against the force of a spring. This effectively prevents any unintentional actuation of the motor drives since the switching points to control the electric-motor drives are reached and control these points only when the user exerts pressure on the hand lever in the forward or rearward directions. Releasing the hand lever automatically causes the hand lever and the switch element associated therewith to return to the rest position.

According to the invention the effort to actuate the second switch by the hand lever is significantly higher than the effort needed to actuate the first switch. A track including a first ball guided within the track is provided on the switch element, and the ball is held between the track on one side and the first end of a helical spring on the other side, and is positively guided within the track. Another ball is provided and guided between the other end of the helical spring and a housing wall. Furthermore the track is deeper in the region between the first switching positions and the second positions than between the first positions and the rest position. A depression corresponding to the ball's shape is provided at each switching position.

Provision of a ball that is guided in this way within a track along the switch element and is held against the force of a spring enables feedback to be conveyed to the user as to which switching position the hand lever is located at that moment. A greater effort when operating the hand lever is thus required to reach the second switching positions from the first positions than to reach the first switching position from the rest position. The depressions provided within the track form detent in the position, and the ball after reaching the respective switching position rolls into the depression and first has to be pushed out of this position when a further actuation is effected.

A click sound is furthermore produced when the ball rolls into the depression, which sound also conveys acoustic feedback to the visitor that the switching position has been reached. This then provides a reliable and simple means of giving tactile and acoustic feedback to the user about the respective switching points when the hand lever is operated.

### BRIEF DESCRIPTION OF THE DRAWING

The above and other objects, features, and advantages will become more readily apparent from the following description, reference being made to the accompanying drawing in which:

FIG. 1 is a section through the lever-type controller of this invention in the rest position;

FIG. 2 is a section like FIG. 1 in a first operating position when rotated 5° in the forward direction;

FIG. 3 is a large-scale view of a detail from FIG. 2;

FIG. 4 is a section like FIG. 1 showing the controller in a second operating position when rotated 11° in the forward direction;

FIG. 5 is a large-scale view of a detail from FIG. 4;

FIG. 6 is a section like FIG. 1 showing the controller in a first operating position when rotated 5° in the rearward direction;

FIG. 7 is a large-scale view of a detail from FIGS. 6;

FIG. 8 is a section like FIG. 1 in a second operating position when rotated 11° in the rearward direction;

FIG. 9 is a large-scale view of a detail from FIG. 8;

FIG. 10 shows a track with ball in the rest position;

FIG. 11 is the same view in the first operating position;

FIG. 12 is the same view in the second operating position; and

FIG. 13 a section through the switch element.

### SPECIFIC DESCRIPTION OF THE INVENTION

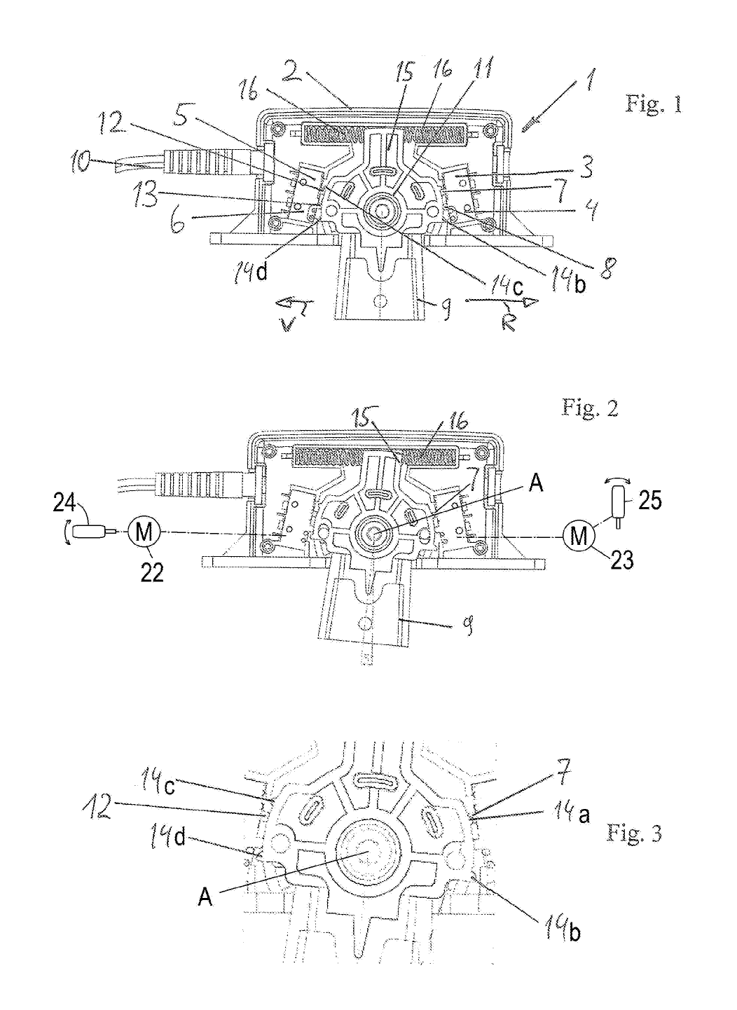

As seen in FIGS. 1, 2, 4, 6, a manual controller 1 functions to control the electric-motor-actuated adjustment of recliner, in particular, a reclining arm chair having two electric drives 22 and 23 (FIG. 2 only) each formed by a motor or actuator. Adjustment can be effected, for example, from a base position to a rearward-shifted comfort position and back to the base position. To this end, the controller 1 has a housing 2 in which various switches 3, 4, 5, and 6 are provided to actuate the electrical drives 22 and 23 of the recliner. The switches 3-6 can be actuated by moving a hand lever 9 that projects from the housing 2 in a forward direction V or rearward direction R. In response to movement of the lever 9 forward or rearward, the electric-motor drives 22 and 23 of the recliner are actuated and adjust it accordingly as described in more detail below. This type of controller 1 according to the invention allows an approach that is known per se for effecting control to be retained, that is, moving the lever 9 forward or rearward, and it provides a significant expansion of functionality by specifically, actuating different motors successively, or different directional motions by one motor successively.

The housing 2 here is of flat rectangular shape and the lever 9 projects approximately centrally from one of its flat longitudinal sides. The lever 9 is connected to a circular switch element 11 that is rotatable in the housing 2 about an axis A. In response to both a forward motion (direction V) by the lever 9 and a rearward motion (direction R) by the lever 9, the element 11 actuates actuating buttons 7 and 12 of the first switches 3 and 5 in the housing 2, and in response to a subsequent motion in the same direction actuates buttons 8 or 13 of second switches 4 and 6. The element 11 here is provided in the housing 2 approximately centrally between the two pairs of switches 3, 4, 5, and 6, and carries four cams 14a, 14b, 14c, and 14d that project toward the switches 3, 4, 5, and 6. The first forward cam 14a and second rearward cam 14b on one side of the element 11 coact with the first and second switches 3 and 4 on the same side and the first rearward cam 14c and second forward cam 14d on the other side of the element 11 coact with the first and second switches 5 and 6 there.

In the rest position, the first cams 14a and 14c are close to the actuating buttons 7 and 12 of the first switches 3 and 5. In a first operating position, the first cams 14a and 14c actuate only these buttons 7 and 12 of the first switches 3 and 5, while when moved further in the same direction to the following position they actuate the buttons 8 and 13 of the second switches 4 and 6 with the second back and forward cams 14b and 14d.

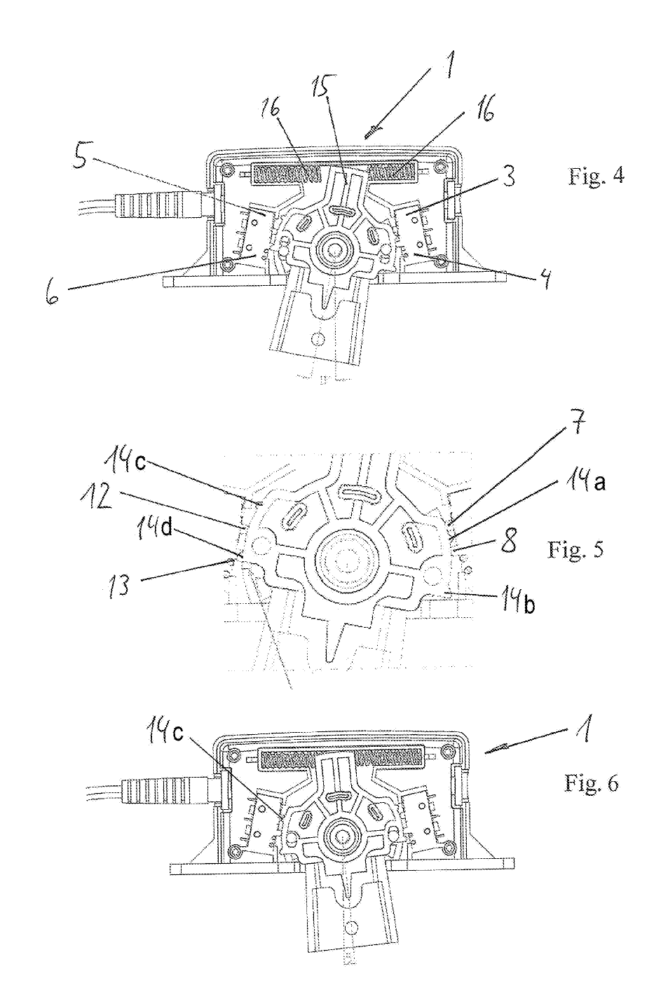

Thus on pivoting the lever 9 through 5° from the rest position of FIG. 1 in the forward direction V as shown in FIGS. 2 and 3 first the first forward cam 14a actuates the button 7 of the first switch 3 on one side and then, when pivoted another 6° for a full stroke of 11° as shown in FIGS. 4 and 5, the second forward cam 14d actuates the button 13 of the second switch 6 on the other side. These diametrically opposite switches 3 and 6 are, for instance, connected to a motor 22 (FIG. 2 only) for raising and lowering a footrest 24 of a recliner so that in the first position (FIGS. 2 and 3), the footrest 24 is raised, but, in the second position pushed 6° further (FIGS. 4 and 5), the footrest 24 is lowered.

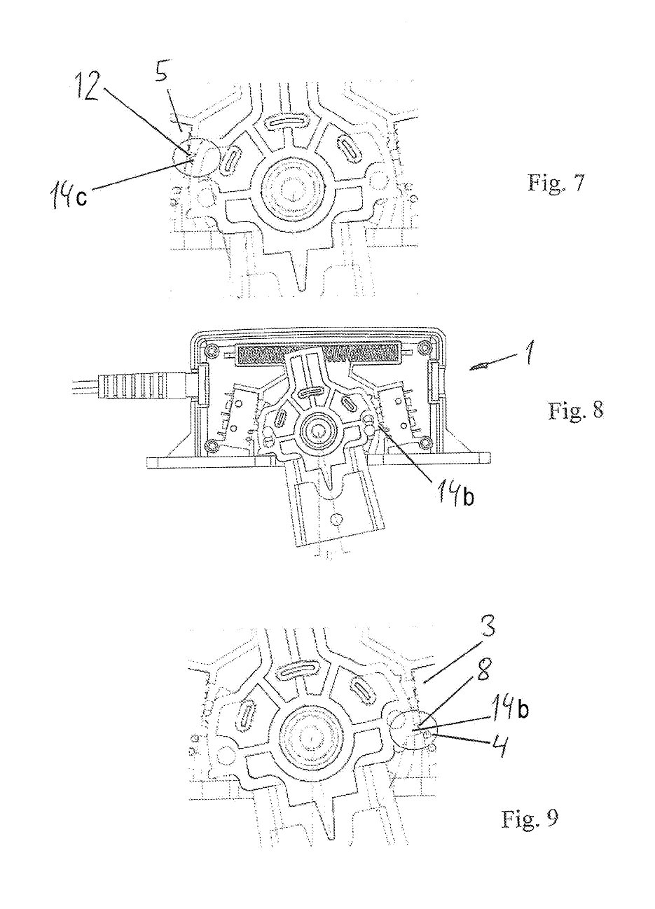

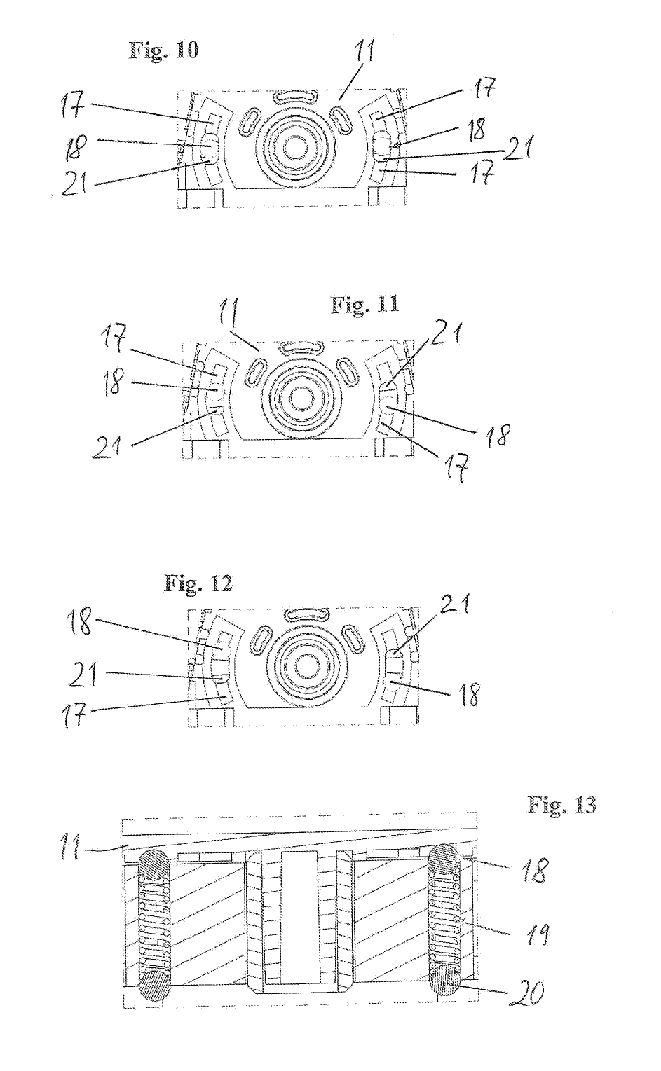

Similarly on pivoting the lever 9 through 5° from the rest position of FIG. 1 in the reverse direction R as shown in FIGS. 6 and 7 first the first rearward cam 14c actuates the button 12 of the first switch 5 on one side and then, when pivoted another 6° for a full stroke of 11° as shown in FIGS. 8 and 9, the second rearward cam 14b actuates the button 8 of the second switch 4 on the other side. These diametrically opposite switches 4 and 5 are, for instance, connected to a motor 23 (FIG. 2 only) raising and reclining a back 25 of the recliner so that in the first position (FIGS. 6 and 7), the back 25 is reclined, but, in the second position pushed 6° further (FIGS. 8 and 9), the back 25 is raised.

Alternately the two switches 3 and 6 operated on forward movement of the lever 9 could raise the back and lower the footrest, and the switches 4 and 5 operated on reverse movement of the lever 9 could raise the footrest and recline the back.

The user therefore has the power to independently control each of two parts of the chair to each do two functions, all by pivoting a single lever through four angularly offset positions.

A projecting arm 15 is provided on the side of the element 11 opposite the lever 9 in order to preclude any unintentional operation of the motor drives. The arm 15 is provided in the housing 2 between two precompressed springs 16, with the result that the lever 9 and the element 11 attached thereto are held in the rest position against the force of springs 16. This ensures, for example, that when the lever 9 is released by the user it is returned by the spring force back to the rest position (FIG. 1).

The effort required to actuate the second switches 4 and 6 by the lever 9 is significantly higher than the effort required to actuate the first switches 3 and 5, thereby providing the simplest possible means of giving tangible feedback to a user about the various switching points. To this end, a track 17 and a first ball 18 guided in the track 17 is provided on the element 11. The ball 18 is held between the track 17 on one side and the first end of a helical spring 19 on the other side, and positively guided within the track 17. Another ball 20 is provided and guided between the other end of helical spring 19 and a housing wall. In addition, the track 17 in the region between the rest position and each of the first switching positions is deeper than in the regions between the first and second switching positions. When the lever 9 is moved to the first switching position, the user thus needs only to apply a smaller effort since the ball 18 is bearing against a lower spring force within the track 17 than in the shallower region between the first and second switching positions. Due to the fact that the track 17 is deeper in the region between the first switching positions and the rest position, adjustment requires that the ball 18 be depressed more against the helical spring 19 in order to move along the track 17 from each first position to the respective second position. This requires an increased effort on the part of the user.

In addition, a depression 21 matching the shape of the ball 18 is provided in the region of each switching position within or on the track 17, the depression forming a detent for the ball 18. As a result, The ball 18 drops each time into the depression 21 when it reaches the switching position, thereby producing both mechanical and acoustic feedback through the lever to the user. The effort required to effect a further adjusting movement out of the depression 21 is also greater so that the user perceives when he/she is leaving the first switching position for the next switching position.

The invention is not limited to the illustrated embodiment but can be varied in multiple ways within the scope of the disclosure. All individual and combined features disclosed in the description and/or the drawing are considered essential to the invention.

I claim:

1. A manual controller for operating two drives of a recliner movable between a base position and a comfort position, the controller comprising:
a housing;
a lever projecting from the housing and movable in a forward direction from a rest position through a first forward position and then into a second forward position and rearward from the rest position through a first rearward position and then into a second rearward position, the first positions lying between the respective second positions and the rest position;
two first switches in the housing each operated by the lever only in a respective one of the first positions; and
two second switches in the housing each operated by the lever only in a respective one of the second positions, two of the switches being connected to one of the drives and the other two of the switches being connected to the other of the drives.

2. The recliner controller defined in claim 1, wherein the lever is pivotal about an axis through the positions and carries an element pivotal about the axis and formed with two first and two second cams respectively engageable with the first switches and second switches on pivoting of the lever.

3. The recliner controller defined in claim 2, wherein the one drive is connected to the first switch of the first forward position and the second switch of the second forward position, and the other drive is connected to the first switch of the first rearward position and the second switch of the second rearward position.

4. The recliner controller defined in claim 3, where the first forward switch is diametrally opposite relative to the axis of the second forward switch and the first rearward switch is diametrally opposite relative to the axis of the second rearward switch.

5. The recliner controller defined in claim 4, wherein the rest position defines a symmetry plane passing through the axis and the first forward and second rearward switches are symmetrically opposite the second forward and first rearward switches relative to the plane.

6. The recliner controller defined in claim 2 wherein the cams are radially outwardly projecting bumps on the element and the switches have radially inwardly depressible actuating buttons engageable by the respective cams.

7. The recliner controller defined in claim 3, wherein the first positions are reached by a 5° rotation of the element from the rest position and the second positions by an 11° rotation of the element.

8. The recliner controller defined in claim 2, further comprising:
spring means urging the lever into the rest position.

9. The recliner controller defined in claim 8, wherein the element is formed with a radially projecting arm, the spring means including a pair of springs tangentially oppositely braced against the arm.

10. The recliner controller defined in claim 2, further comprising:
means for releasably retaining the element in the rest position and each of the first positions.

11. The recliner controller defined in claim 10, wherein the means for retaining the element is operative to retain the element in each of the first positions with a greater force than in the rest position.

12. The recliner controller defined in claim 10, wherein the element is formed with an axially open circularly arcuate track centered on the axis, the means for retaining including a ball seated in the housing and a spring urging the ball into the track.

13. The recliner controller defined in claim 12, wherein the track is deeper between the first positions through the rest position than between each of the first positions and the respective second position.
